(19) United States
(12) Patent Application Publication
(10) Pub. No.: US 2007/0200493 A1
(43) Pub. Date: Aug. 30, 2007

(54) Light-emitting apparatus

(75) Inventors: Tzu-Chieh Hsu, Hsinchu (TW); Ching-San Tao, Hsinchu (TW); Mei-Chun Liu, Hsinchu (TW); Mei-Lan Wu, Hsinchu (TW); Chen Ou, Hsinchu (TW); Min-Hsun Hsieh, Hsinchu (TW)

Correspondence Address: BACON & THOMAS, PLLC, 625 SLATERS LANE, FOURTH FLOOR, ALEXANDRIA, VA, 22314, US

(73) Assignee: EPISTAR CORPORATION, Hsinchu (TW)

(21) Appl. No.: 11/581,439

(22) Filed: Oct. 17, 2006

(30) Foreign Application Priority Data
Oct. 19, 2005 (TW) 94136605

(51) Int. Cl. H01J 1/62; H01J 63/04

(52) U.S. Cl. 313/506

(57) ABSTRACT

The light-emitting apparatus comprises a substrate, a first semiconductor layer formed on the substrate, a light-emitting layer formed on the first semiconductor layer, a second semiconductor layer formed on the light-emitting layer, a first transparent conductive oxide layer formed on the second semiconductor layer, a reflective metal layer form on the transparent conductive oxide layer, and a first electrode formed on the reflective metal layer; characterized in that the first transparent conductive oxide layer is formed with a plurality of cavities on the interface between the first transparent conductive oxide layer and the reflective metal layer for improving the adhesion strength therebetween.

### REFERENCE TO RELATED APPLICATION

This application claims the right of priority based on TW application Ser. No. 94136605, filed Oct. 19, 2005, entitled Light-emitting Apparatus, and the contents of which are incorporated herein by reference.

### BACKGROUND OF THE INVENTION

1. Technical Field

This invention relates to a light-emitting diode device, and more particularly to a high light extraction light-emitting diode device.

2. Description of the Related Art

Light-emitting diode (LED) devices are widely used in different fields such as displays, traffic lights, data storage apparatus, communication apparatus, lighting apparatus, and medical apparatus. One important task for engineers is to increase the brightness of the LED devices.

In a prior art LED device, a metal layer, such as a Ti/Au or Cr/Au layer, is used as an electrode. However, the metal absorbs light and results in a low light-emitting efficiency of the LED device. The US patent publication 2005/0072968 discloses an LED device including a reflective metal layer formed between an electrode and a light-emitting stacked layer for improving the light-emitting efficiency. However, the aforementioned structure brings about the reliability and peeling issues between the reflective metal layer and a light-emitting stacked layer. Usually, these issues are caused by the poor adhesion between the reflective metal layer with high reflectivity and a semiconductor layer of the light-emitting stacked layer.

### SUMMARY OF THE INVENTION

The present invention has been achieved in contemplation of resolving the above issues. An object of the invention is to provide a light-emitting device including a transparent conductive oxide layer having a first surface facing a light-emitting stacked layer and a second surface with a first plurality of cavities facing a first reflective metal layer for improving the adhesion strength between the transparent conductive oxide layer and the first reflective metal layer.

The light-emitting device comprises a substrate, a first semiconductor layer formed on the substrate, a light-emitting layer formed on the first semiconductor layer, a second semiconductor layer formed on the light-emitting layer, a first transparent conductive oxide layer formed on the second semiconductor layer, a reflective metal layer formed on the transparent conductive oxide layer, and a first electrode formed on the reflective metal layer; characterized in that the first transparent conductive oxide layer has a first surface facing the second semiconductor layer and a second surface with a first plurality of cavities facing the reflective metal layer.

In accordance with an additional feature of the invention, the light-emitting device further comprises a second transparent conductive oxide layer with a plurality of cavities formed between the first semiconductor layer and a second electrode.

In accordance with a further feature of the invention, the light-emitting device further comprises a binding layer, formed between the substrate and the light-emitting stacked layer including the first semiconductor layer, the light-emitting layer, and the second semiconductor layer; and a third transparent conductive oxide layer formed between the binding layer and the light-emitting stacked layer.

In accordance with another feature of the invention, it is preferable that the area of the first electrode and that of the reflective metal layer are substantially the same. When the area of the reflective metal layer is slightly greater than that of the first electrode, almost all of the light emitted to the first electrode is reflected to avoid being absorbed by the first electrode. However, the area of light extraction is reduced when the area of the first reflective metal layer is too large. Accordingly, we can adjust the area of the first reflective metal layer to get a high light extraction efficiency.

### BRIEF DESCRIPTION OF THE DRAWINGS

FIG. 1 is a vertical sectional view of a light-emitting device in accordance with a first embodiment of the present invention.

FIG. 2 is a vertical sectional view of a light-emitting device in accordance with a second embodiment of the present invention.

FIG. 3 is a top view of a second semiconductor layer in accordance with a second embodiment of the present invention.

FIG. 4A is an SEM diagram showing a surface morphology of an ITO layer in a conventional four-element LED device.

FIG. 4B is an SEM diagram showing an interface morphology between an ITO layer and a reflective metal layer in a conventional four-element LED device.

FIG. 5A is an SEM diagram showing a surface morphology of an ITO layer in a conventional Nitride LED device.

FIG. 5B is an SEM diagram showing an interface morphology between an ITO layer and a reflective metal layer in a conventional Nitride LED device.

FIG. 6A is an SEM diagram showing a surface morphology of an ITO layer in accordance with a second embodiment of the present invention.

FIG. 6B is an SEM diagram showing an interface morphology between an ITO layer and a reflective metal layer in accordance with a second embodiment of the present invention.

FIG. 7A is a vertical sectional view of a light-emitting device of a third embodiment according to the present invention.

FIG. 7B is an SEM diagram showing a surface morphology of a first semiconductor layer in accordance with a third embodiment of the present invention.

FIG. 7C is an SEM diagram showing a surface morphology of a second transparent conductive layer in accordance with a third embodiment of the present invention.

FIG. 8 is a vertical sectional view of a light-emitting device in accordance with a fourth embodiment of the present invention.

FIG. 9 is a vertical sectional view of a light-emitting device in accordance with a fifth embodiment of the present invention.

FIG. 10 is a vertical sectional view of a light-emitting device in accordance with a sixth embodiment of the present invention.

### DETAILED DESCRIPTION OF THE PREFERRED EMBODIMENTS

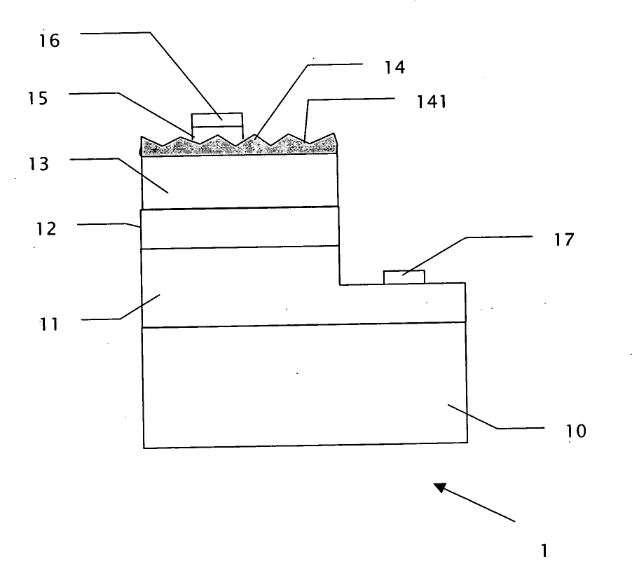

Referring to FIG. 1, a light-emitting device 1 comprises a substrate 10; a first semiconductor layer 11 formed on the substrate 10; a light-emitting layer 12 formed on the first semiconductor layer 11; a second semiconductor layer 13 formed on the light-emitting layer 12; a first transparent conductive oxide layer 14 including a first surface in contact with the second semiconductor layer 13 and a second surface, which is opposite to the first surface, with a first plurality of cavities 141, formed on the second semiconductor layer 13; a first reflective metal layer 15 formed on the first plurality of cavities 141 of the second surface; a first electrode 16 formed on the first reflective metal layer 15; and a second electrode 17 formed on the first semiconductor layer 11. Each cavity of the first plurality of cavities 141 is shaped into a cone or a pyramid by an etching process. The plurality of cavities are extended downwards from the second surface of the first transparent conductive layer, and preferably to be perpendicular to the substrate 10.

The first transparent conductive oxide layer 14 is made of indium tin oxide (ITO), cadmium tin oxide (CTO), antimony tin oxide, zinc indium oxide, aluminum zinc oxide, zinc antimony oxide, or the combinations thereof; and is formed by an E-beam evaporation method, an ion-sputtering method, a thermal-evaporation method, or any combination thereof. For example, the thickness of the ITO layer is from 50 nm to 1 um and the transmissivity is above 50% when the range of the related wavelength is from 300 nm to 700 nm.

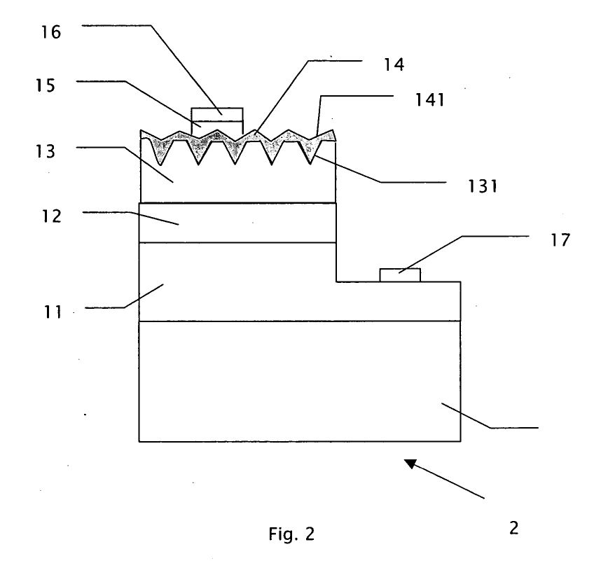

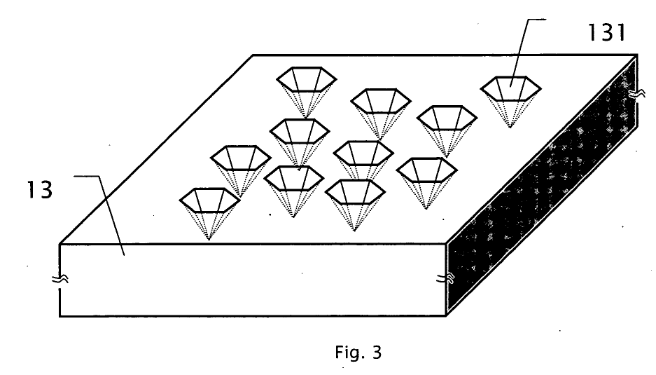

Referring to FIG. 2, the difference between the second embodiment and the first embodiment lies in that the second semiconductor layer 13 is etched to form a second plurality of cavities 131 and then the first transparent oxide layer 14 is deposited on the plurality of cavities 131 to form the first plurality of cavities 141 which can improve the adhesion between the first transparent oxide layer 14 and the first reflective metal layer 15. The second plurality of cavities 131 are shaped into cones or pyramids (as shown in FIG. 3) and formed by an epitaxy method, an etching method, or the combination thereof.

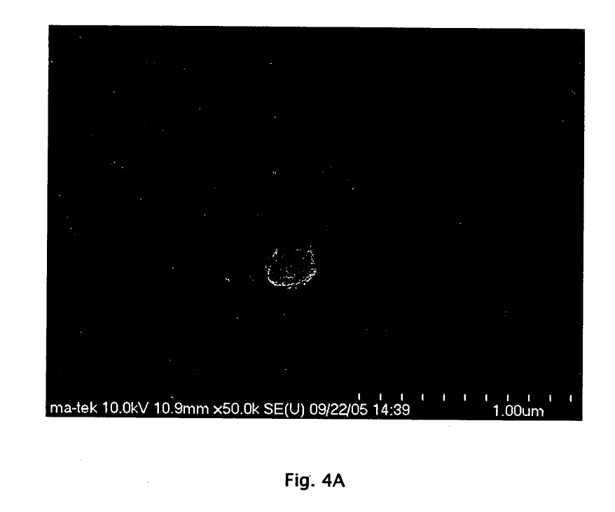

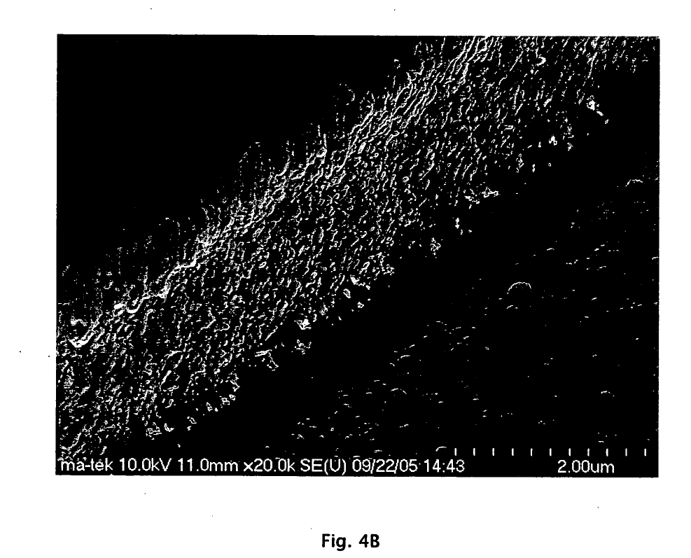

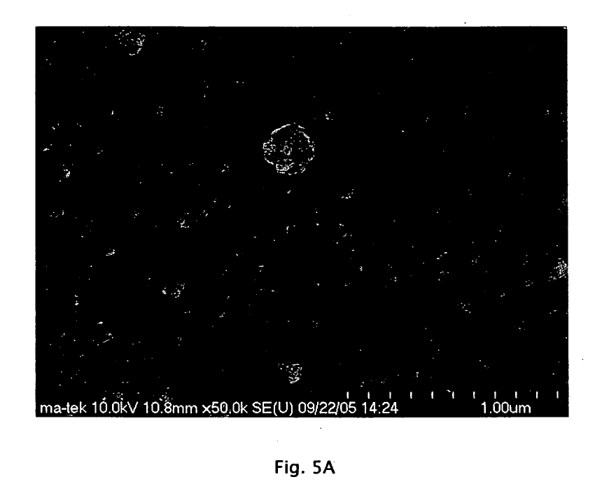

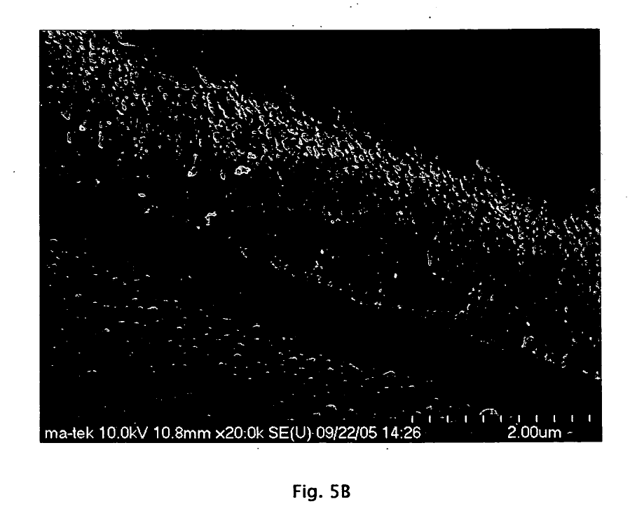

FIG. 4A is an SEM diagram showing a surface morphology of a transparent conductive layer (ITO layer) formed on a light-emitting stacked layer in a conventional four-element (AlGaInP) LED device, which is a flat surface. FIG. 4B is an SEM diagram showing an interface morphology between the transparent conductive oxide layer (ITO layer) and a reflective metal layer in a conventional four-element LED device, which has a peeling issue. Moreover, FIG. 5A is an SEM diagram showing a surface morphology of a transparent conductive layer (ITO layer) formed on a light-emitting stacked layer in a conventional nitride LED device, the surface being a flat surface. FIG. 5B is an SEM diagram showing an interface morphology between the transparent conductive oxide layer (ITO layer) and a reflective metal layer (Al layer) in a conventional nitride LED device, which has a peeling issue as well.

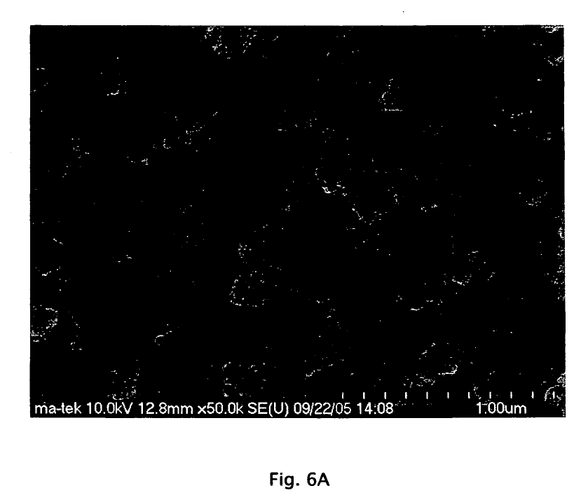

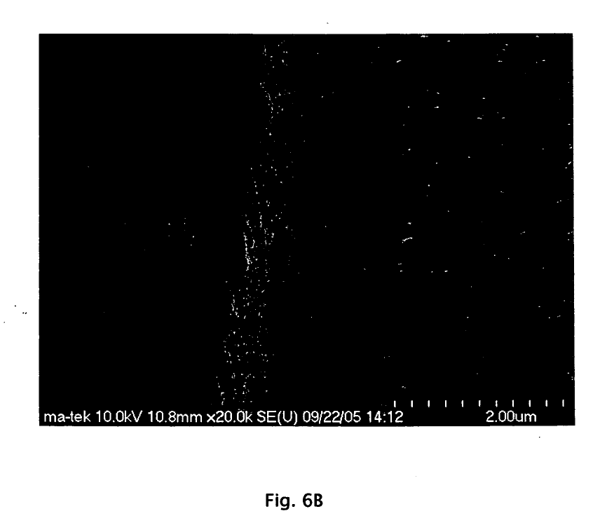

In accordance with the second embodiment of the present invention, the second plurality of cavities 131 are extended downwards from the surface of the second semiconductor layer 13 and make the first transparent conductive oxide layer 14 formed on the second semiconductor layer 13 conformally have the first plurality of cavities 141. The adhesion strength between the first reflective metal layer 15 and the first transparent conductive oxide layer 14 has been improved by the first plurality of cavities 141. The result of a peeling test of the second embodiment and the conventional LED device without cavities on the surface of the first transparent oxide layer shows that all the devices in accordance with the second embodiment passed the peeling test, but more than 80% of the conventional LED devices failed with the peeling test. FIG. 6A is an SEM diagram showing a surface morphology of a transparent conductive layer (ITO layer) 14 formed on a light-emitting stacked layer in the second embodiment, which has cavities structure. FIG. 6B is an SEM diagram showing an interface morphology between the transparent conductive oxide layer (ITO layer) 14 and the reflective metal layer 15 in the second embodiment, which shows a good adhesion.

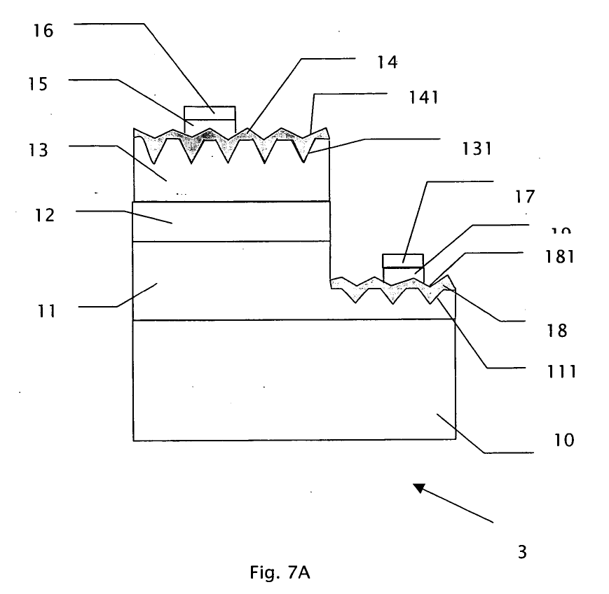

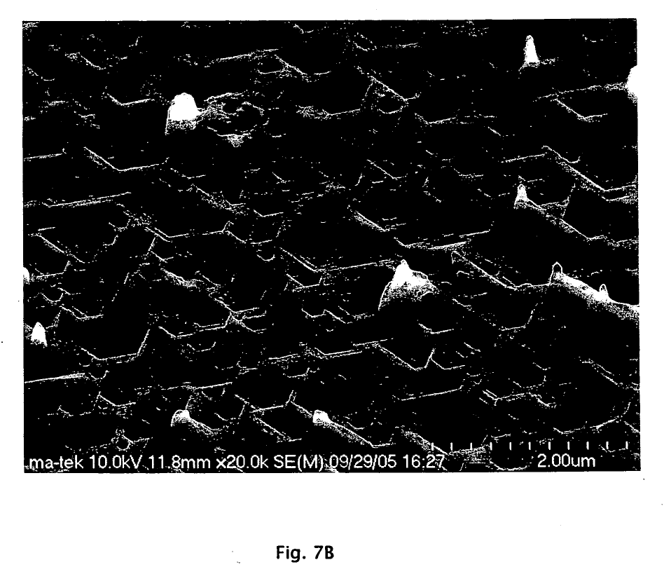

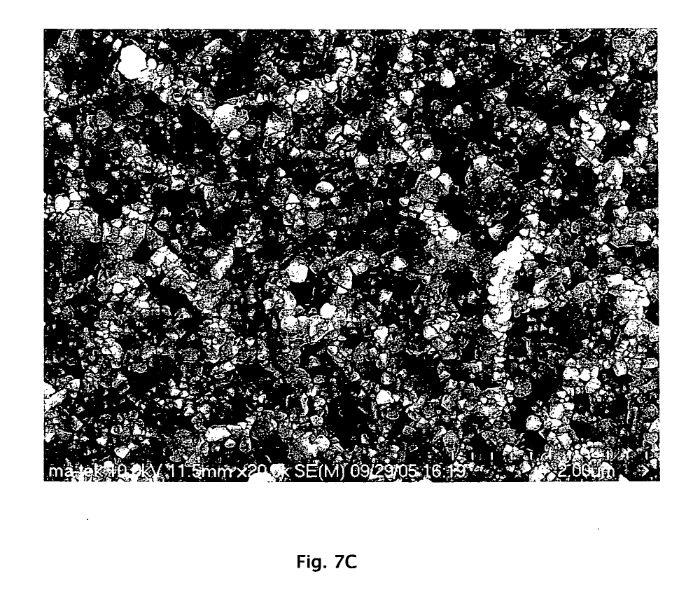

FIG. 7A is a vertical sectional view of a light-emitting device 3 in accordance with a third embodiment of the present invention. The difference between the third embodiment and the second embodiment is that the first semiconductor layer 11 is etched to form a fourth plurality of cavities 111 and than deposit a second transparent conductive oxide layer 18 on the fourth plurality of cavities 111 to form a third plurality of cavities 181 which can improve the adhesion between the second transparent oxide layer 18 and a second reflective metal layer 19. FIG. 7B is an SEM diagram showing a surface morphology of the fourth plurality of cavities 111 of the fist semiconductor layer 11. FIG. 7C is an SEM diagram showing a surface morphology of the third plurality of cavities 181 of the second transparent conductive metal layer 18. The peeling test performed between the second reflective metal layer 19 and the second transparent conductive oxide layer 18 shows that there is no peel-off due to the third plurality of cavities 181.

A comparison of the light efficiency between the light-emitting device 3 in accordance with the third embodiment and a conventional LED device without the reflective metal layer shows that the luminance/luminous intensity of the third embodiment is (10.68 lm)/(154.87 mW) and the luminance/luminous intensity of the conventional LED device is (9.721 lm)/(137.25 mW) when the input current is 350 mA. It is apparent that the light-emitting device 3 has better performance than the conventional LED device does.

In addition, in accordance with the third embodiment, the second transparent conductive layer 18 can be formed directly on the first semiconductor layer 11 without the fourth plurality of cavities 111 and then an etching process is performed to form the third plurality of cavities 181.

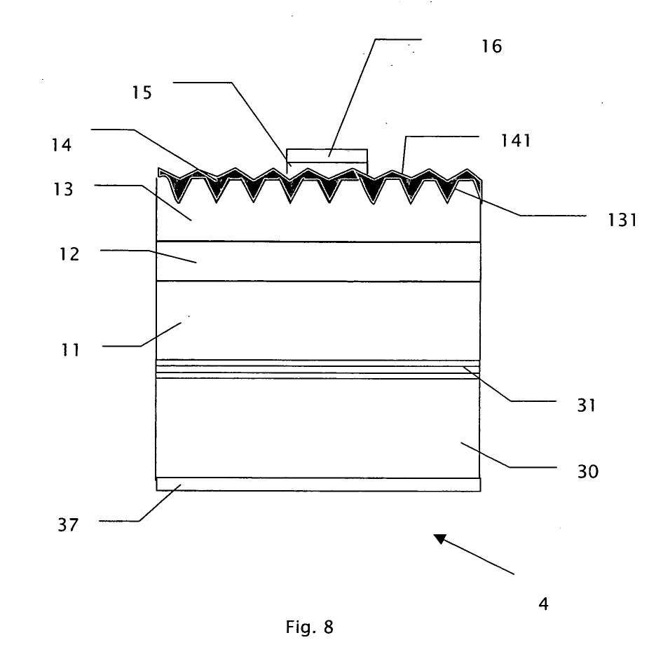

FIG. 8 is a vertical sectional view of a light-emitting device 4 in accordance with a fourth embodiment of the present invention. The difference between the fourth embodiment and the first embodiment is that the substrate 10 is replaced by a conductive substrate 30, an additional Distributed Bragg Reflector layer (DBR layer) 31 is formed between the conductive substrate 30 and the first semiconductor layer 11, and a third electrode 37 is formed under the conductive substrate 30.

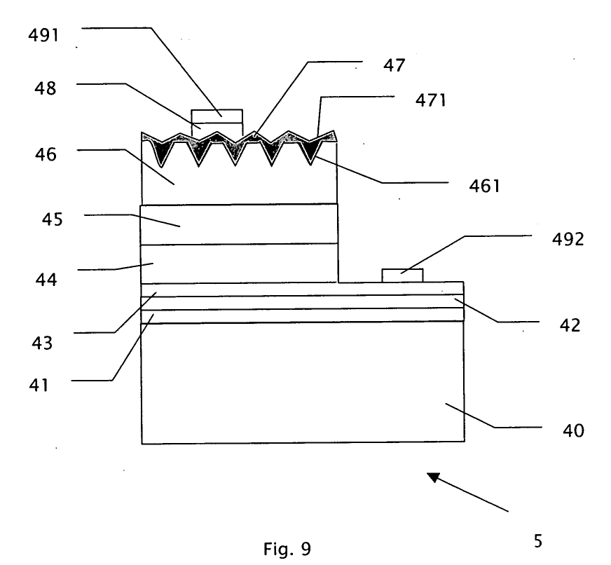

FIG. 9 is a vertical sectional view of a light-emitting device 5 in accordance with a fifth embodiment of the present invention, which comprises a substrate 40, a reflective layer 41, a dielectric binding layer 42, a third transparent conductive oxide layer 43, a first semiconductor layer 44, a light-emitting layer 45, a second semiconductor layer 46, and a first transparent conductive oxide layer 47 stacked sequentially. The light-emitting device 5 further comprises a first plurality of cavities 471 on the upper surface of the first transparent conductive oxide layer 47, a first reflective metal layer 48 formed on the first plurality of cavities 471, a first electrode 491 formed on the first reflective metal layer 48 and a second electrode 492 formed on the third transparent conductive oxide layer 43.

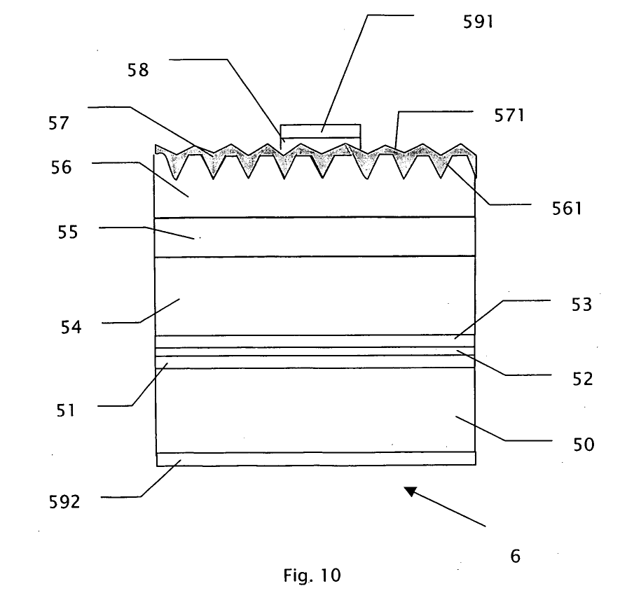

FIG. 10 is a vertical sectional view of a light-emitting device 6 in accordance with a sixth embodiment of the invention, which comprises a conductive substrate 50, a metal binding layer 51, a reflective layer 52, a third transparent conductive oxide layer 53, a first semiconductor layer 54, a light-emitting layer 55, a second semiconductor layer 56, and a first transparent conductive oxide layer 57 stacked sequentially. The light-emitting device 6 further comprises a first plurality of cavities 571 formed on the upper surface of the first transparent conductive oxide layer 57, a first reflective metal layer 58 formed on the first plurality of cavities 571, a first electrode 591 formed on the first reflective metal layer 58 and a second electrode 592 formed under the conductive substrate 50.

In the aforementioned embodiments, the substrates (10 and 40) are made of sapphire, SiC, GaAs, GaN, AlN, GaP, Si, ZnO, MgO, glass, or the combination thereof, and the conductive substrates (30 and 50) are made of SiC, GaAs, GaN, AlN, GaP, Si, or the combination thereof.

In the aforementioned embodiments, all the plurality of cavities (111, 131, 141, 181, 461, 471, and 561) are shaped into cones or pyramids, wherein the plurality of cavities (131, 461, and 561) are formed by an etching process or an epitaxy process, and the plurality of cavities (111, 141, 181, and 471) are formed by an etching process.

In the aforementioned embodiments, the first semiconductor layers (11, 44, and 54) and the second semiconductor layers (13, 46, and 56) are made of AlGaInP, AlInP, InGaP, AlN, GaN, AlGaN, InGaN, AlInGaN, or the combination thereof and the light-emitting layers (12, 45, and 55) are made of AlGaInP, InGaP, AlInP, GaN, InGaN, AlInGaN, or the combination thereof. Moreover, the transparent conductive oxide layers (14, 18, 43, 47, 53, and 57) are made of indium tin oxide (ITO), cadmium tin oxide (CTO), antimony tin oxide, zinc indium oxide, aluminum zinc oxide, zinc antimony oxide, or the combination thereof. The dielectric binding layer 42 is made of Poly-imides (PI), Benzocyclobutene (BCB), Prefluorocyclobutane (PFCB), or the combination thereof. The metal binding layer 51 is made of indium (In), tin (Sn), gold-tin (AuSn), or the combination thereof.

In the aforementioned embodiments, the DBR layer 31 is formed by stacked semiconductor layers and the reflective layers (41 and 52) are made of In, Sn, Ai, Au, Pt, Zn, Ag, Ti, Pb, Pd, Ge, Cu, AuBe, AuGe, Ni, PbSn, AuZn, or the combination thereof. The first and second reflective metal layers (15, 19, 48, and 58) are made of Al or Ag.

The foregoing description has been directed to specific embodiments of this invention. It will be apparent, however, that other variations and modifications may be made to the described embodiments, with the attainment of some or all of their advantages. Therefore, it is the object of the appended claims to cover all such variations and modifications that fall within the spirit and scope of the invention.

What is claimed is:

1. A light-emitting apparatus comprising:
a light-emitting stacked layer;
a first transparent conductive oxide layer formed on said light-emitting stacked layer, having a first surface facing said light-emitting stacked layer and a second surface with a first plurality of cavities; and
a first reflective metal layer formed on said first plurality of cavities of said first transparent conductive oxide layer.

2. The light-emitting apparatus according to claim 1, wherein said light-emitting stacked layer further comprises a second plurality of cavities in contact with said first transparent conductive oxide layer.

3. The light-emitting apparatus according to claim 2, wherein said first plurality of cavities is extended to said second plurality of cavities.

4. The light-emitting apparatus according to claim 1, wherein said light-emitting stacked layer comprises a first semiconductor layer; a light-emitting layer formed on said first semiconductor layer; and a second semiconductor layer formed on said light-emitting layer.

5. The light-emitting apparatus according to claim 1, further comprising a substrate formed below said light-emitting stacked layer.

6. The light-emitting apparatus according to claim 1, wherein said first transparent conductive oxide layer is selected form the group consisting of indium tin oxide (ITO), cadmium tin oxide (CTO), antimony tin oxide, zinc indium oxide, aluminum zinc oxide, zinc antimony oxide, and the combinations thereof.

7. The light-emitting apparatus according to claim 1, wherein the thickness of said transparent conductive oxide layer is from 50 nm to 1 um.

8. The light-emitting apparatus according to claim 6, wherein said substrate is selected form the group consisting of GaN, AlN, SiC, GaAs, GaP, Si, ZnO, MgO, MgAl₂O₄, glass, sapphire, and the combination thereof.

9. The light-emitting apparatus according to claim 1, wherein said light-emitting stacked layer is selected form the group consisting of AlGaInP, AlGaIn, GaInP, AlN, GaN, AlGaN, InGaN, AlInGaN, and the combination thereof.

10. The light-emitting apparatus according to claim 1, wherein said first plurality of cavities are formed by an etching process.

11. The light-emitting apparatus according to claim 2, wherein said second plurality of cavities are formed by an epitaxy process, an etching process, or the combination thereof.

12. The light-emitting apparatus according to claim 1, further comprising a first electrode formed on said first reflective metal layer.

13. The light-emitting apparatus according to claim 4, further comprising a second transparent conductive oxide layer with a third plurality of cavities formed on said first semiconductor layer.

14. The light-emitting apparatus according to claim 13, wherein said first semiconductor layer further comprises a fourth plurality of cavities in contact with second transparent conductive oxide layer.

15. The light-emitting apparatus according to claim 13, further comprising a second reflective metal layer formed on said second transparent conductive oxide layer and a second electrode formed on said second reflective metal layer.

16. The light-emitting apparatus according to claim 14, wherein said third plurality of cavities and said fourth plurality of cavities are formed by an etching process.

17. The light-emitting apparatus according to claim 13, wherein said second transparent conductive oxide layer is selected form the group consisting of indium tin oxide (ITO), cadmium tin oxide (CTO), antimony tin oxide, zinc indium oxide, aluminum zinc oxide, zinc antimony oxide, and the combinations thereof.

18. The light-emitting apparatus according to claim 15, wherein said first reflective metal layer and said second reflective metal layer are selected form the group consisting of Al, Ag, and the combinations thereof.

19. The light-emitting apparatus according to claim 5, further comprising a binding layer formed between said light-emitting stacked layer and said substrate.

20. The light-emitting apparatus according to claim 19, wherein said binding layer is a dielectric binding layer or a metal binding layer.

21. The light-emitting apparatus according to claim 20, wherein said dielectric binding layer is selected form the group consisting of Poly-imides (PI), Benzocyclobutene (BCB), Prefluorocyclobutane (PFCB), and the combinations thereof.

22. The light-emitting apparatus according to claim 20, wherein said metal binding layer is selected form the group consisting of In, Sn, AuSn, and the combinations thereof.

23. The light-emitting apparatus according to claim 19, further comprising a third transparent conductive oxide layer formed between said light-emitting stacked layer and said binding layer.

24. The light-emitting apparatus according to claim 23, wherein said third transparent conductive oxide layer is selected form the group consisting of indium tin oxide (ITO), cadmium tin oxide (CTO), antimony tin oxide, zinc indium oxide, aluminum zinc oxide, zinc antimony oxide, and combinations thereof.

25. The light-emitting apparatus according to claim 2, wherein said first plurality of cavities and said second plurality of cavities are shaped into cones or pyramids.

26. The light-emitting apparatus according to claim 14, wherein said third plurality of cavities and said fourth plurality of cavities are shaped into cones or pyramids.

27. The light-emitting apparatus according to claim 12, wherein the area of said first reflective metal layer is substantially the same as the area of said first electrode.
